(19) United States
(12) Patent Application Publication
(10) Pub. No.: US 2019/0322603 A1
(43) Pub. Date: Oct. 24, 2019

(54) ELECTRICALLY OPERATED PROPELLANTS AND METHODS OF MAKING AND USE THEREOF

(71) Applicant: Ohio State Innovation Foundation, Columbus, OH (US)

(72) Inventor: Vishnu Baba Sundaresan, Columbus, OH (US)

(21) Appl. No.: 16/389,091

(22) Filed: Apr. 19, 2019

Related U.S. Application Data
(60) Provisional application No. 62/659,798, filed on Apr. 19, 2018.

(51) Int. Cl. C06B 21/00; C06B 43/00; C06B 45/10

(52) U.S. Cl. CPC C06B 21/0025; B33Y 80/00; C06B 45/10; C06B 43/00

(57) ABSTRACT

Disclosed herein are electrically operated propellants and methods of making and use thereof. The electrically operated propellants comprise a thermoplastic ionomer and a carbonaceous material. The electrically operated propellants are air stable and are configured to ignite at an ignition condition, wherein the ignition condition is that a physical defect is introduced and an electrical input is applied after the introduction of the physical defect, to thereby ignite the electrically operated propellant.

### CROSS-REFERENCE TO RELATED APPLICATIONS

This application claims the benefit of priority to U.S. Provisional Application No. 62/659,798, filed Apr. 19, 2018, which is hereby incorporated herein by reference in its entirety.

### STATEMENT OF GOVERNMENT SUPPORT

This invention was made with government support under Grant No. 1463103 awarded by the National Science Foundation. The government has certain rights in the invention.

### BACKGROUND

Manufacturing and safe handling of military hardware is essential for the safety of the armed forces. Most materials used in military hardware are toxic, highly flammable, and require extra care during handling, storage, and disposal. Military hardware that will undergo rapid exothermic reaction only when desired and otherwise are safe and easily handled are needed. The compositions and methods described herein address these and other needs.

### SUMMARY

In accordance with the purposes of the disclosed compositions, methods, and systems as embodied and broadly described herein, the disclosed subject matter relates to electrically operated propellants and methods of making and use thereof.

Additional advantages of the disclosed compositions, methods, and systems will be set forth in part in the description which follows, and in part will be obvious from the description.

The advantages of the disclosed compositions, methods, and systems will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying drawings, which are incorporated in and constitute a part of this specification, illustrate embodiments and together with the description, serve to explain the principles of the methods and systems:

FIG. 1 is an image of the extruded melt-mixed ionomer-multi-walled carbon nanotube (MWCNT) composite composition.

FIG. 2 is an image of the coupon of the ionomer-MWCNT composite formed by melt pressing the premixed pellets.

FIG. 3 is a scanning electron microscopy image of the melt pressed coupon of the ionomer-MWCNT composite.

FIG. 4 is an image of the melt pressed coupon of the ionomer-MWCNT composite with conductive filaments attached thereto, and wherein the conductive filaments were attached to a voltage source.

FIG. 5 is an image of the exothermic reaction occurring in the ionomer-MWCNT composite upon applying a voltage to the melt pressed coupon of the ionomer-MWCNT composite via the conductive filaments.

FIG. 6 is an image of the exothermic reaction occurring in the ionomer-MWCNT composite upon applying a voltage to the melt pressed coupon of the ionomer-MWCNT composite via the conductive filaments.

FIG. 7 is an image of the exothermic reaction occurring in the ionomer-MWCNT composite upon applying a voltage to the melt pressed coupon of the ionomer-MWCNT composite via the conductive filaments.

FIG. 8 is an image of the exothermic reaction occurring in the ionomer-MWCNT composite upon applying a voltage to the melt pressed coupon of the ionomer-MWCNT composite via the conductive filaments.

FIG. 9 is an image of strands of a composite material comprising Surlyn and carbon black in varying amounts.

FIG. 10 is an image of strands of a composite material comprising Surlyn and carbon black in varying amounts.

FIG. 11 is a schematic diagram of an example system for applying voltage across the composites described herein, with reference numeral 1 indicating the composite material, reference numeral 2 indicating carbon fibers attached to the composite material, and reference numeral 3 indicating a power supply attached to the carbon fibers and configured to apply a voltage across the composite material.

FIG. 12 is a photograph of the example system schematically shown in FIG. 11.

FIG. 13 is a series of photos showing the progression of the exothermic reaction occurring in the composite upon applying a voltage.

FIG. 14 is a series of photos showing the progression of the exothermic reaction occurring in the composite upon applying a voltage.

### DETAILED DESCRIPTION

The compositions, methods, and systems described herein may be understood more readily by reference to the following detailed description of specific aspects of the disclosed subject matter and the Examples included therein.

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

“Exemplary” means “an example of” and is not intended to convey an indication of a preferred or ideal embodiment. “Such as” is not used in a restrictive sense, but for explanatory purposes.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Disclosed herein are electrically operated propellants. The electrically operated propellants can be configured to ignite at an ignition condition, wherein the ignition condition is that a physical defect is introduced and an electrical input is applied after the introduction of the physical defect, to thereby ignite the electrically operated propellant.

The electrically operated propellants comprise a thermoplastic ionomer and a carbonaceous material. The electrically operated propellants described herein can be air stable. In some examples, the electrically operated propellants can consist of the thermoplastic ionomer and the carbonaceous material.

Any suitable thermoplastic ionomer can be used. For example, the ionomer can include at least one of a polyolefin, polyamide, polyester, ionene, poly(trimethylene terephthalate), copoly(ether-ester), copoly(ester-ester), polyamide, polyether, copoly(urethane-ester), copoly(urethane-ether), polyacrylate, polystyrene, styrene-butadiene-styrene copolymer, styrene-ethylene-butylene-styrene copolymer, polypropylene, ethylene-propylene-diene terpolymer or ethylene-propylene copolymer rubber, and a polycarbonate, or a homopolymer, copolymer, block copolymer, or a mixture thereof.

In some examples, the thermoplastic ionomer can comprise an ionene copolymer, an ethylene copolymer ionomer, or a combination thereof. In some examples, the thermoplastic ionomer can comprise an ionene polymer or copolymer, such as a poly(alkylene oxide-co-ionenes) (e.g., poly(propylene glycol)-based ammonium ionenes and poly(ethylene glycol)-based ammonium ionenes) and poly(dialkyl siloxane-co-ionenes) (e.g., poly(dimethyl siloxane)-based ammonium ionenes). In some examples, the ionene copolymer can comprise a poly(propylene glycol)-based ionene copolymer, a poly(ethylene glycol)-based ionene copolymer, a poly(dimethyl siloxane)-based ionene copolymer, or a combination thereof.

In some examples, the thermoplastic ionomer can comprise an ethylene copolymer ionomer. Suitable ethylene copolymer ionomers can be copolymers of ethylene; a carboxylic acid-containing monomer, such as a C₃ to C₁₂ (e.g., a C₃ to C₈, or a C₃ to C₆) α, β-ethylenically unsaturated mono- or dicarboxylic acid; and optionally a softening monomer. Copolymers may include, without limitation, ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymers, and the like. The term “(co)polymer” includes homopolymers, copolymers, or mixtures thereof. The term, “copolymer,” as used herein, includes polymers having two types of monomers, those having three types of monomers, and those having more than three types of monomers. Examples of suitable a, 0-ethylenically unsaturated mono- or dicarboxylic acids include (meth)acrylic acid, ethacrylic acid, maleic acid, crotonic acid, fumaric acid, itaconic acid. As used herein, “(meth)acrylic acid” means methacrylic acid and/or acrylic acid. Likewise, “(meth)acrylate” means methacrylate and/or acrylate.

When a softening monomer is present, such copolymers can be referred to as E/X/Y-type copolymers, wherein E is ethylene; X is a carboxylic acid-containing monomer, such as a C3 to C12 (e.g., a C3 to C8, or a C₃ to C₆) α, β-ethylenically unsaturated mono- or dicarboxylic acid; and Y is a softening monomer. The softening monomer can be, for example, a (meth)acrylate monomer, such as an alkyl (meth)acrylate monomer wherein the alkyl group has from 1 to 12 carbon atoms (e.g., from 1 to 8 carbon atoms, from 1 to 6 carbon atoms, or from 1 to 4 carbon atoms). Optionally, such polymers can optionally further include one or more additional ethylenically-unsaturated monomers. Examples of E/X/Y-type copolymers are those wherein X is (meth)acrylic acid and/or Y is selected from (meth)acrylate, n-butyl (meth)acrylate, isobutyl (meth)acrylate, methyl (meth)acrylate, and ethyl (meth)acrylate. In certain cases, the E/X/Y-type copolymer can be ethylene/(meth)acrylic acid/n-butyl acrylate, ethylene/(meth)acrylic acid/methyl acrylate, and ethylene/(meth)acrylic acid/ethyl acrylate.

The amount of ethylene in the acid copolymer can be at least 15 wt. % (e.g., at least 25 wt. %, at least 40 wt. %, or at least 60 wt. %), based on total weight of the monomers used to form the copolymer. The amount of carboxylic acid-containing monomer, such as a C₃ to C₁₂ (e.g., a C₃ to C₈, or a C₃ to C₆) α, β-ethylenically unsaturated mono- or dicarboxylic acid can be from 1 wt. % to 35 wt. % (e.g., from 5 wt. % to 30 wt. %, from 5 wt. % to 25 wt. %, or from 10 wt. % to 20 wt. %), based on total weight of the monomers used to form the copolymer. The amount of optional softening comonomer in the copolymer can be from 0 wt. % to 50 wt. % (e.g., from 5 wt. % to 40 wt. %, from 10 wt. % to 35 wt. %, or from 20 wt. % to 30 wt. %), based on total weight of the monomers used to form the copolymer based on total weight of the monomers used to form the copolymer. “Low acid” and “high acid” ionomeric polymers, as well as blends of such ionomers, can also be used. In general, low acid ionomers are considered to be those containing 16 wt. % or less of acid moieties, whereas high acid ionomers are considered to be those containing greater than 16 wt. % of acid moieties.

The acidic groups in the ionomers can be partially or totally neutralized with a cation source. Suitable cation sources include metal cations and salts thereof, organic amine compounds, ammonium, and combinations thereof. Examples of cation sources include metal cations and salts thereof, wherein the metal is can be lithium, sodium, potassium, magnesium, calcium, barium, lead, tin, zinc, aluminum, manganese, nickel, chromium, copper, or a combination thereof. The metal cation salts provide the cations capable of neutralizing (at varying levels) the carboxylic acids of the ethylene acid copolymer and fatty acids, if present, as discussed further below. These include, for example, the sulfate, carbonate, acetate, oxide, or hydroxide salts of lithium, sodium, potassium, magnesium, calcium, barium, lead, tin, zinc, aluminum, manganese, nickel, chromium, copper, or a combination thereof. In certain embodiments, the metal cation salts can be calcium and magnesium-based salts. High surface area cation particles such as micro and nano-scale cation particles can be desirable in certain circumstances. The amount of cation used in the composition is readily determined based on desired level of neutralization.

In certain examples, the ethylene copolymer ionomer can be derived from (i) ethylene; (ii) one or more (meth)acrylate monomers; (iii) one or more carboxylic acid-containing monomers; and (iv) optionally one or more additional ethylenically-unsaturated monomers, excluding monomers (i)-(iii).

Any electrically conductive carbonaceous material can be used in the electrically operated propellants described herein. The carbonaceous material can, for example, comprise activated carbon, charcoal, coal, carbon black, amorphous carbon, mesocarbon, a graphitic material, or combinations thereof.

In some examples, the carbonaceous material can comprise a graphitic material. The term “graphitic,” as used herein can thus include a wide range of graphene-based materials including, for example, graphene, graphene oxide, graphite, graphite oxide, chemically converted graphene, functionalized graphene, functionalized graphene oxide, functionalized graphite oxide, functionalized chemically converted graphene, carbon nanotubes, and combinations thereof. The term “graphene,” as used herein, refers to planar materials that include from one to several atomic monolayers of sp²-bonded carbon atoms. In some examples, the graphitic material can comprise graphene, graphene oxide, graphite, carbon nanotubes, or a combination thereof.

The carbonaceous material can, for example, be present in the electrically operated propellant in a volume fraction of 1% or more (e.g., 1.5% or more, 2% or more, 2.5% or more, 3% or more, 3.5% or more, 4% or more, 4.5% or more, 5% or more, 6% or more, 7% or more, 8% or more, 9% or more, 10% or more, 15% or more, 20% or more, 25% or more, 30% or more, 35% or more, or 40% or more). In some examples, the carbonaceous material can be present in the electrically operated propellant in a volume fraction of 50% or less (e.g., 45% or less, 40% or less, 35% or less, 30% or less, 25% or less, 20% or less, 15% or less, 10% or less, 9% or less, 8% or less, 7% or less, 6% or less, 5% or less, 4.5% or less, 4% or less, 3.5% or less, 3% or less, 2.5% or less, or 2% or less). The volume fraction of the carbonaceous material in the electrically operated propellant can range from any of the minimum values described above to any of the maximum values described above. For example, the carbonaceous material can be present in the electrically operated propellant in a volume fraction of from 1% to 50% (e.g., from 1% to 40%, from 1% to 30%, from 1% to 25%, from 1% to 20%, from 1% to 15%, from 1% to 10%, or from 1% to 5%).

The carbonaceous material can, in some examples, comprise a plurality of particles. The plurality of particles can have an average particle size. “Average particle size” and “mean particle size” are used interchangeably herein, and generally refer to the statistical mean particle size of the particles in a population of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. Mean particle size can be measured using methods known in the art, such as evaluation by scanning electron microscopy, transmission electron microscopy, and/or dynamic light scattering.

The plurality of particles can, for example, have an average particle size of 2 nanometers (nm) or more (e.g., 3 nm or more, 4 nm or more, 5 nm or more, 10 nm or more, 15 nm or more, 20 nm or more, 30 nm or more, 40 nm or more, 50 nm or more, 75 nm or more, 100 nm or more, 125 nm or more, 150 nm or more, 200 nm or more, 250 nm or more, 300 nm or more, 400 nm or more, 500 nm or more, 750 nm or more, 1 micrometer (micron, μm) or more, 2 μm or more, 3 μm or more, 4 μm or more, 5 μm or more, 10 μm or more, 15 μm or more, 20 μm or more, 25 μm or more, or 30 μm or more). In some examples, the plurality of particles can have an average particle size of 50 micrometers (microns, μm) or less (e.g., 45 μm or less, 40 μm or less, 35 μm or less, 30 μm or less, 25 μm or less, 20 μm or less, 15 μm or less, 10 μm or less, 5 μm or less, 4 μm or less, 3 μm or less, 2 μm or less, 1 μm or less, 750 nm or less, 500 nm or less, 400 nm or less, 300 nm or less, 250 nm or less, 200 nm or less, 150 nm or less, 125 nm or less, 100 nm or less, 75 nm or less, 50 nm or less, 40 nm or less, 30 nm or less, 20 nm or less, 15 nm or less, 10 nm or less, or 5 nm or less). The average particle size of the plurality of particles can range from any of the minimum values described above to any of the maximum values described above. For example, the plurality of particles can have an average particle size of from 2 nm to 50 microns (e.g., from 2 nm to 20 μm, from 2 nm to 1 μm, from 2 nm to 500 nm, from 2 nm to 100 nm, from 10 nm to 500 nm, from 1 μm to 30 μm, or from 15 μm to 25 μm).

In some examples, the plurality of particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the mean particle size (e.g., within 20% of the mean particle size, within 15% of the mean particle size, within 10% of the mean particle size, or within 5% of the mean particle size).

In some examples, the carbonaceous material can comprise carbon nanotubes. Carbon nanotubes have been studied intensively since their discovery in 1991. Nanotubes are found in single sheet wall or multi-wall forms in a wide range of diameters and lengths. In some examples, the carbon nanotubes can comprise single-walled carbon nanotubes, multi-walled carbon nanotubes, or a combination thereof. The carbon nanotubes can, for example, have an average diameter 2 nanometers (nm) or more (e.g., 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, or 90 nm or more). In some examples, the carbon nanotubes can have an average diameter of 100 nm or less (e.g., 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, or 5 nm or less). The average diameter of the carbon nanotubes can range from any of the minimum values described above to any of the maximum values described above. For example, the carbon nanotubes can have an average diameter of from 2 nm to 100 nm (e.g., from 2 nm to 50 nm, from 50 nm to 100 nm, from 2 nm to 20 nm, from 20 nm to 40 nm, from 40 nm to 60 nm, from 60 nm to 80 nm, from 80 nm to 100 nm, from 5 nm to 95 nm, or from 10 nm to 90 nm).

In some examples, the carbon nanotubes have an average length of 10 nm or more (e.g., 20 nm or more, 30 nm or more, 40 nm or more, 50 nm or more, 60 nm or more, 70 nm or more, 80 nm or more, 90 nm or more, 100 nm or more, 110 nm or more, 120 nm or more, 130 nm or more, 140 nm or more, 150 nm or more, 160 nm or more, 170 nm or more, or 180 nm or more).

In some examples, the carbon nanotubes can have an average length of 200 nm or less (e.g., 190 nm or less, 180 nm or less, 170 nm or less, 160 nm or less, 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, or 30 nm or less). The average length of the carbon nanotubes can range from any of the minimum values described above to any of the maximum values described above. For example, the carbon nanotubes can have an average length of from 10 nm to 200 nm (e.g., from 10 nm to 100 nm, from 100 nm to 200 nm, from 10 nm to 40 nm, from 40 nm to 80 nm, from 80 nm to 120 nm, from 120 nm to 160 nm, from 160 nm to 200 nm, from 20 nm to 180 nm, or from 30 nm to 150 nm). In some examples, the carbon nanotubes have an average aspect ratio (e.g., ratio of length to diameter) of 0.1 or more (e.g., 0.5 or more, 1 or more, 1.5 or more, 2 or more, 2.5 or more, 3 or more, 3.5 or more, 4 or more, 4.5 or more, 5 or more, 6 or more, 7 or more, 8 or more, 9 or more, 10 or more, 15 or more, 20 or more, 25 or more, 30 or more, 35 or more, 40 or more, 45 or more, 50 or more, 60 or more, 70 or more, or 80 or more). In some examples, the carbon nanotubes can have an average aspect ratio of 100 or less (e.g., 90 or less, 80 or less, 70 or less, 60 or less, 50 or less, 45 or less, 40 or less, 35 or less, 30 or less, 25 or less, 20 or less, 15 or less, 10 or less, 9 or less, 8 or less, 7 or less, 6 or less, 5 or less, 4.5 or less, 4 or less, 3.5 or less, 3 or less, 2.5 or less, 2 or less, 1.5 or less, or 1 or less). The average aspect ratio of the carbon nanotubes can range from any of the minimum values described above to any of the maximum values described above. For example, the carbon nanotubes can have an average aspect ratio of from 0.1 to 100 (e.g., from 0.1 to 50, from 50 to 100, from 0.1 to 20, from 20 to 40, from 40 to 60, from 60 to 80, from 80 to 100, from 0.1 to 2, from 2 to 5, from 5 to 100, from 0.1 to 5, from 2 to 100, or from 10 to 90).

Also described herein are methods of producing three-dimensional structures comprising the electrically operated propellants, for example by additive manufacturing. Additive manufacturing, also known as three-dimensional (3D) printing, synthesizes a three-dimensional workpiece by successively forming, under computer control, layers of materials to create an object. In some examples, the methods can comprise producing the three-dimensional structure on a layer-by-layer basis by depositing a plurality of layers on a layer-by-layer basis, wherein each layer comprises any of the electrically operated propellants described herein.

Also disclosed herein are the three-dimensional structures comprising the electrically operated propellants made by the additive manufacturing methods described herein. Also disclosed herein are methods of use of the electrically operated propellants described herein and/or the three-dimensional structures described herein. The methods of use can, for example, comprise introducing a physical defect into the electrically operated propellant and/or the three-dimensional structure. The physical defect can comprise a microscopic and/or macroscopic defect. For example, introducing the physical defect can comprise mechanically cutting or abrading a surface of the electrically operated propellant and/or the three-dimensional structure, thereby introducing a physical defect in the form of a cut and/or abrasion. In some examples, the physical defect can be introduced into the three-dimensional structure during the additive manufacturing. For example, the physical defect can be introduced into the electrically operated propellant and/or the three-dimensional structure by forming microcracks during the additive manufacturing, during assembly, or in the lattice structure of the electrically operated propellant and/or the three-dimensional structure.

After introducing the physical defect, the methods can further comprise applying an electrical input to the electrically operated propellant and/or the three-dimensional structure comprising the physical defect, thereby igniting the electrically operated propellant. The electrical input, when applied to the electrically operated propellant and/or the three-dimensional structure comprising the physical defect, can arc across the physical defect, thereby igniting the electrically operated propellant. The extent of the physical defect (e.g., the size of the physical defect) introduced into the electrically operated propellant and/or the three-dimensional structure can determine the magnitude of the electrical input needed to trigger the exothermic reaction in the electrically operated propellant. Thus, the extent of the physical defect can be selected in view of a variety of factors, for example, the electrical input needed to initiate, sustain, or quench the exothermic reaction in the electrically operated propellant. In some examples, the electrical input can comprise a field strength of 100 kiloVolts per meter (kV/m) or more (e.g., 150 kV/m or more, 200 kV/m or more, 250 kV/m or more, 300 kV/m or more, 350 kV/m or more, 400 kV/m or more, 450 kV/m or more, 500 kV/m or more, 550 kV/m or more, 600 kV/m or more, 650 kV/m or more, 700 kV/m or more, 750 kV/m or more, 800 kV/m or more, 850 kV/m or more, or 900 kV/m or more). In some examples, the electrical input can comprise a field strength of 1 megaVolt per meter (MV/m) or less (e.g., 950 kV/m or less, 900 kV/m or less, 850 kV/m or less, 800 kV/m or less, 750 kV/m or less, 700 kV/m or less, 650 kV/m or less, 600 kV/m or less, 550 kV/m or less, 500 kV/m or less, 450 kV/m or less, 400 kV/m or less, 350 kV/m or less, 300 kV/m or less, 250 kV/m or less, or 200 kV/m or less). The electrical input applied to the electrically operated propellant and/or the three-dimensional structure comprising the physical defect can range from any of the minimum values described above to any of the maximum values described above. For example, the electrical input can comprise a field strength of from 100 kV/m to 1 MV/m (e.g., from 100 kV/m to 550 kV/m, from 550 kV/m to 1 MV/m, from 100 kV/m to 400 kV/m, from 400 kV/m to 700 kV/m, from 700 kV/m to 1 MV/m, from 200 kV/m to 900 kV/m, or from 300 kV/m to 800 kV/m).

In some examples, the igniting of the electrically operated propellant is used during the launch or flight of a vehicle or munitions.

For example, the electrically operated propellant can be configured to perform as a solid rocket engine to provide thrust through a rocket nozzle upon ignition at the ignition condition. In some examples, the electrically operated propellant can be configured to perform as a propellant for a munition. For example, the electrically operated propellant can form a layer (e.g., a shell) at least partially encasing a munition.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

Toward the goal of creating military hardware that will undergo rapid exothermic reaction only when required, described herein are blends of ionomers and graphitic materials (e.g., multiwalled carbon nanotubes, singled walled carbon nanotubes, graphite powder, etc.) as alternatives to contemporary hardware. Some advantages of these composite materials are as follows: (i) composites of ionomers and graphitic materials can be 3D printed via fused deposition modeling, eliminating the need to manufacture hardware years ahead of time and stockpiling; (ii) the composite materials can be safely handled in open air, and in hot environments, since an electrical stimulus is needed to trigger the rapid exothermic reaction; and (iii) the composite material can be fabricated into any shape/form and packaged accordingly.

The resins or polymers used in standard rapid prototyping methods require temperatures that are sufficiently high to affect the functional properties of smart material constituents. To overcome this technical obstacle, smart material composites based on thermoplastic ionomers may be employed. Ionomers are a category of polymers that contain a small fraction of charged groups. These charged groups and their counterions induce the formation of ionic aggregates in the polymer at temperatures below melting temperature (Tm). By increasing the temperature above Tm (melt temperature), the polymer softens due to effective weakening of the forces that bind these ionic aggregates. The temperature required to process many ionomers, including poly(ethylene-co-methacrylic acid) (commercially available from DuPont under the trade name SURLYN®), are low enough to render these ionomers compatible with most smart material components. Further, the charged groups in the ionomer can promote better adhesion of the polymer to the particulate phase.

While any thermoplastic ionomer can in principle be suitable for use in conjunction with the compositions and methods described herein, poly(ethylene-co-methacrylic acid) (commercially available from DuPont under the trade name SURLYN®) was selected for proof-of-principle studies. SURLYN® is an amorphous copolymer of ethylene/methacrylic acid (E/MAA) that is partially neutralized with sodium ions. It has a well-defined melt temperature and can be thermally cycled 100× before the onset of polymer degradation. It is commercially available from DuPont™ as pellets in which methacrylic acid is partially neutralized by lithium, sodium, magnesium, or zinc. However, the concepts described herein be extended to other ion- containing polymers, such as ionenes.

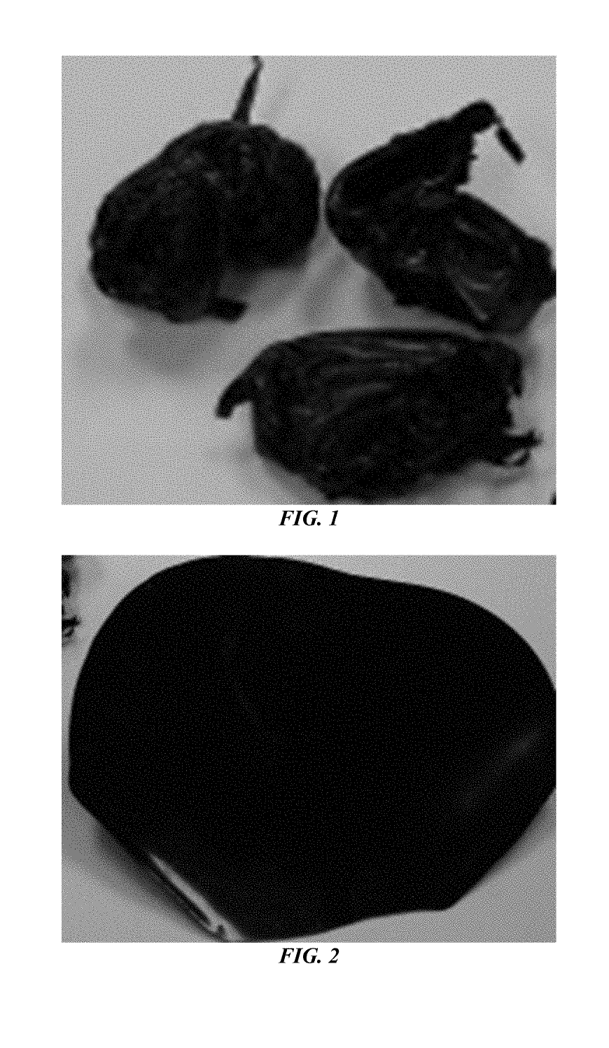

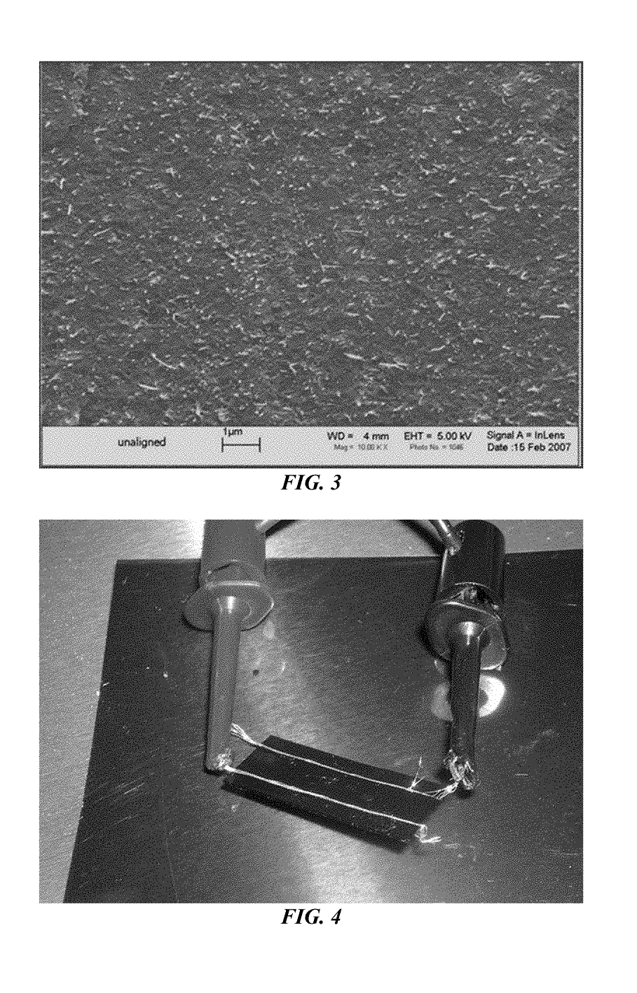

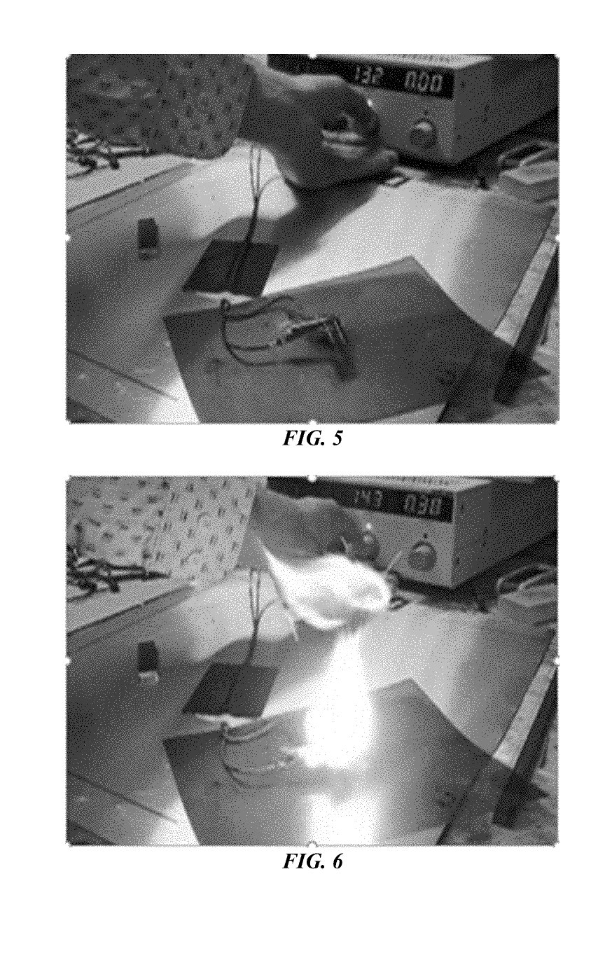

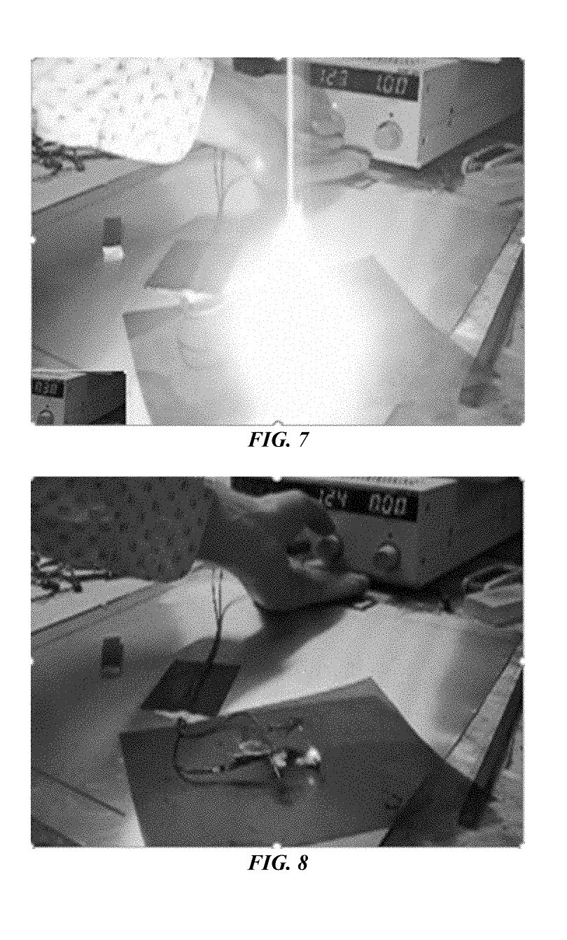

SURLYN® can be fabricated by melt processing into various geometries owing to its molecular structure. Herein, an extruder was employed to premix 36 g of E/MAA ionomer with 10 g of MWCNT. Blends of ionomer composites with carbon-based materials were formed by melt-mixing. An image of the extruded melt-mixed composition is shown in FIG. 1. The premixed pellets were subsequently melt pressed into coupons (FIG. 2). A scanning electron microscopy image of the melt pressed coupon of the ionomer-MWCNT composite is shown in FIG. 3. Conductive filaments were attached to the melt pressed coupon of the ionomer-MWCNT composite, and the conductive filaments were attached to a voltage source (FIG. 4). Upon applying a voltage to the melt pressed coupon of the ionomer-MWCNT composite via the conductive filaments, an exothermic reaction occurred, as shown over time in FIGS. 5-8.

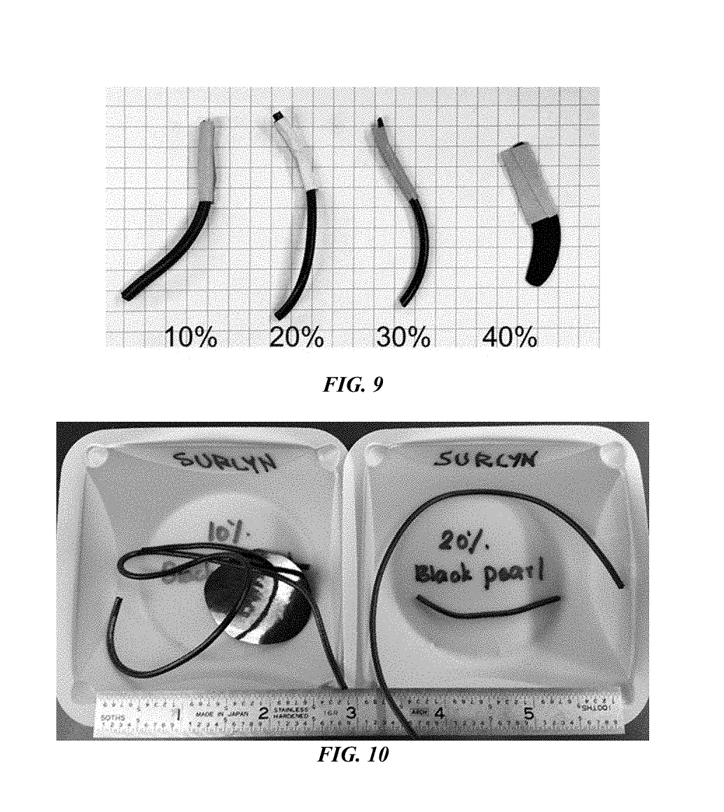

Similarly, a composite material comprising Surlyn and carbon black (Regal 660 from Cabot corp) were combined in varying amounts and formed into strands (FIG. 9 and FIG. 10).

The composite materials comprising ionomers and graphitic materials can be used in applications such as 3D printed military hardware, where uncontrolled exothermic reaction may be required, and 3D printed solid rocket motors for manufacture in a distant moon or planet.

For example, the polymer based composites can release energy at controllable rates on demand by the controlled introduction of a physical defect into the polymer based composite and the subsequent application of an electric field. The physical defect can, in some examples, comprise microscopic defects in the matric introduced during the fabrication of the polymer composite. In the presence of an electric field, the defects can conduct electricity via the formation of an electrical arc. This leads any flammable additive in the polymer based composite to oxidize and release energy. By controlling the formation of the arc via the electrical field, the is possible to maintain a pre-determined rate required for propulsion. Further, due to the volatile nature of the organic matrix of the polymer based composite, sublimation of the solid phase of the polymer composite is observed after arcing. The hot gases leave the polymer through the defect(s) and establish a flame that can be subsequently regulated for controlled power output. These two paths provide various degrees of freedom for controlling the exothermic reaction such that this concept can be leveraged for applications such as propulsion, steering, and on-demand munitions. The power output and rate of energy release from the polymer based composites can also be controlled, for example, by controlling the homogeneity of the carbonaceous material incorporated within the polymer based composite (e.g., homogeneous size of the carbonaceous material and/or homogeneous distribution of the carbonaceous material throughout the composite).

In addition, if the polymer based composite was used as the shell for a conventional munition, it would lead to the creation of a munition device that would vanish after use (e.g., a disappearing bomb). Further, replacement of the conventional shell of the conventional munitions with these polymer based composites would decrease the overall mass of the payload, allowing the munition to be propelled further with the same energy input. The air and moisture stability of the polymer based composites would also make it easier to handle the munitions.

### Example 2

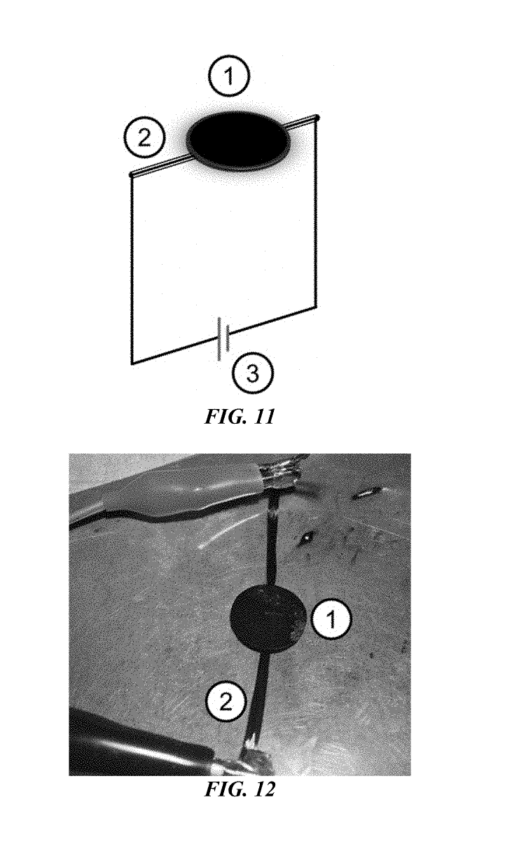

FIG. 11 is a schematic diagram of an example system for applying voltage across the composites described herein, with reference numeral 1 indicating the composite material, reference numeral 2 indicating carbon fibers attached to the composite material, and reference numeral 3 indicating a power supply attached to the carbon fibers and configured to apply a voltage across the composite material. FIG. 12 is a photograph of the example system schematically shown in FIG. 11.

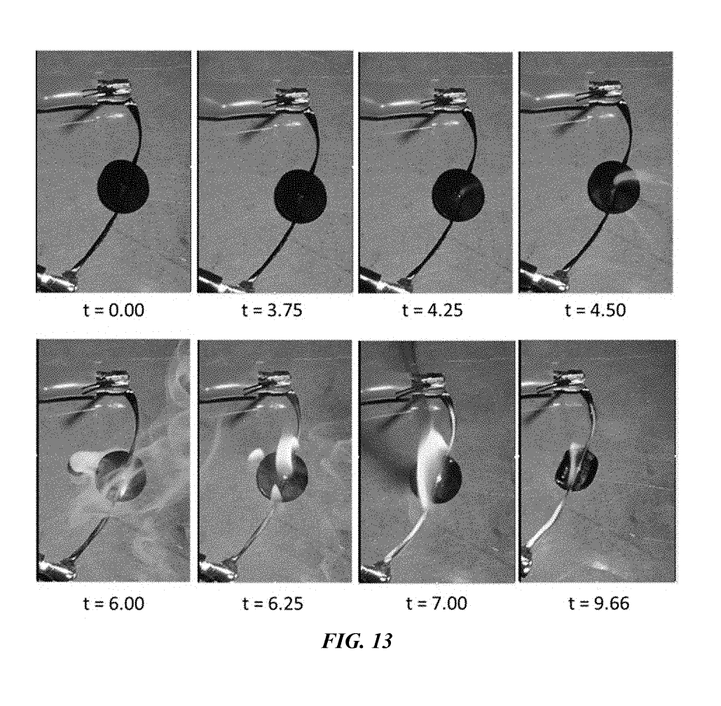

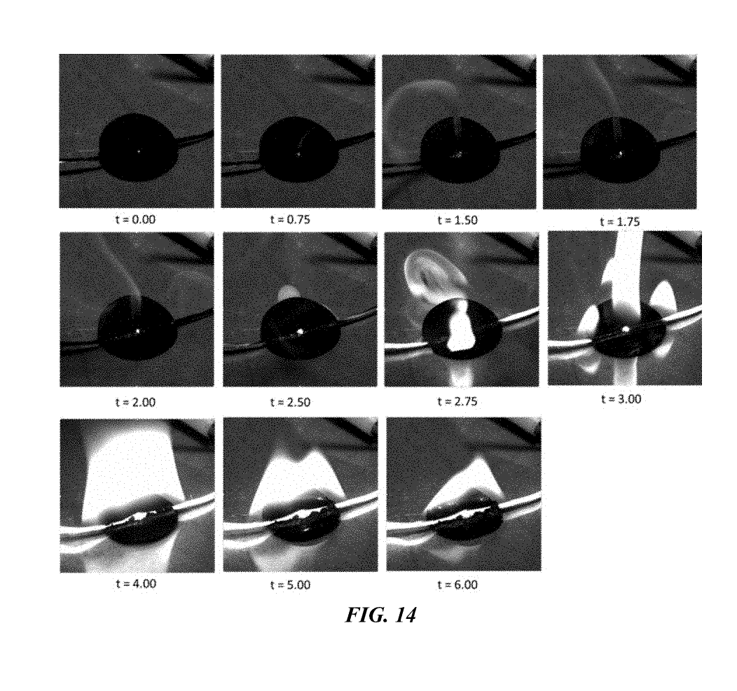

FIG. 13 and FIG. 14 are a series of photos showing the progression of the exothermic reaction occurring in the composite upon applying a voltage.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. An electrically operated propellant comprising:
a thermoplastic ionomer, and
a carbonaceous material,
wherein the electrically operated propellant is air stable, and
wherein the electrically operated propellant is configured to ignite at an ignition condition, wherein the ignition condition is that a physical defect is introduced and an electrical input is applied after the introduction of the physical defect, to thereby ignite the electrically operated propellant.

2. The electrically operated propellant of claim 1, wherein the thermoplastic ionomer comprises an ionene copolymer, an ethylene copolymer ionomer, or a combination thereof.

3. The electrically operated propellant of claim 2, wherein the ionene copolymer comprises a poly(propylene glycol)-based ionene copolymer, a poly(ethylene glycol)-based ionene copolymer, a poly(dimethyl siloxane)-based ionene copolymer, or a combination thereof.

4. The electrically operated propellant of claim 2, wherein the ethylene copolymer ionomer is derived from:
(i) ethylene;
(ii) one or more (meth)acrylate monomers;
(iii) one or more carboxylic acid-containing monomers; and
(iv) optionally one or more additional ethylenically-unsaturated monomers, excluding monomers (i)-(iii).

5. The electrically operated propellant of claim 1, wherein the carbonaceous material comprises activated carbon, charcoal, coal, carbon black, amorphous carbon, mesocarbon, a graphitic material, or combinations thereof.

6. The electrically operated propellant of claim 1, wherein the carbonaceous material comprises a graphitic material and the graphitic material comprises graphene, graphene oxide, graphite, carbon nanotubes, carbon nanofibers, or a combination thereof.

7. The electrically operated propellant of claim 1, wherein the carbonaceous material comprises a plurality of particles having an average particle size of from 2 nanometers to 50 micrometers.

8. The electrically operated propellant of claim 6, wherein the graphitic material comprises carbon nanotubes and the carbon nanotubes comprise single-walled carbon nanotubes, multi-walled carbon nanotubes, or a combination thereof.

9. The electrically operated propellant of claim 8, wherein the carbon nanotubes have an average diameter of from 2 nanometers (nm) to 100 nm, an average length of from 10 nm to 200 nm, an average aspect ratio of from 0.1 to 100, or a combination thereof.

10. The electrically operated propellant of claim 1, wherein the carbonaceous material is present in the electrically operated propellant in a volume fraction of from 1% to 50%.

11. A method of producing a three-dimensional structure using additive manufacturing, the method comprising producing the three-dimensional structure on a layer-by-layer basis by depositing a plurality of layers on a layer-by-layer basis, wherein each layer comprises the electrically operated propellant of claim 1.

12. The method of claim 11, wherein physical defects are introduced into the three-dimensional structure during the additive manufacturing.

13. A three-dimensional structure made by the method of claim 11.

14. A method of using the electrically operated propellant of claim 1, the method comprising:
introducing a physical defect into the electrically operated propellant, and
applying an electrical input to the electrically operated propellant or the three-dimensional structure comprising the physical defect,
thereby igniting the electrically operated propellant.

15. The method of claim 14, wherein introducing the physical defect comprises cutting and/or abrading the electrically operated propellant, introducing microcracks into the electrically operated propellant, or a combination thereof.

16. The method of claim 14, wherein the electrical input comprises a field strength of from 100 kV/m to 1 MV/m.

17. The method of claim 14, wherein the igniting of the electrically operated propellant is used during the launch or flight of a vehicle or munitions.

18. A method of using a three-dimensional structure made by the method of claim 12, the method comprising:
applying an electrical input to the three-dimensional structure comprising the physical defect,
thereby igniting the electrically operated propellant or the three-dimensional structure.

19. The method of claim 18, wherein the electrical input comprises a field strength of from 100 kV/m to 1 MV/m.

20. The method of claim 18, wherein the igniting of the electrically operated propellant is used during the launch or flight of a vehicle or munitions.
